(19) United States
(12) Patent Application Publication
(10) Pub. No.: US 2025/0139647 A1
(43) Pub. Date: May 1, 2025

(54) AUTOMATED PRODUCT AUTHENTICITY VERIFICATION VIA BLOCKCHAIN

(71) Applicant: The Boeing Company, Arlington, VA (US)

(72) Inventors: Aishwarya Balaji, Winnipeg, CA (US); Aishwarya Gururaj, Bengaluru (IN); Sijo Varghese, Thrissur (IN); Dhanalakshmi D. Pillai, Bengaluru (IN)

(21) Appl. No.: 18/494,057

(22) Filed: Oct. 25, 2023

(51) Int. Cl. G06Q 30/018

(52) U.S. Cl. CPC G06Q 30/0185

(57) ABSTRACT

A method for automatic product authenticity verification includes, at an authentication computing system, computer-recognizing one or more observed identifying parameters of a candidate physical product, the candidate physical product associated with a product identifier. The authentication computing system computer-identifies a block of a digital blockchain referencing the product identifier, the block including one or more recorded identifying parameters for a genuine physical product. An authenticity of the candidate physical product is computer-evaluated by automatically comparing the one or more observed identifying parameters of the candidate physical product to the one or more recorded identifying parameters for the genuine physical product.

### FIELD

The invention relates generally to automated authentication of physical products, and more particularly, to the use of blockchain technologies to enable automated comparison between a received product and recorded characteristics of a known genuine product.

### BACKGROUND

A digital blockchain is sometimes described as a “digital ledger,” in which transactions, events, and/or other data entries are encoded in a series of blocks in a data structure collectively maintained by a plurality of different computing devices. As computing devices generate new records for inclusion in the blockchain, new blocks are added to the chain by all computing device nodes, while existing blocks are preserved and remain unchanged. Each new block includes a hash value corresponding to the preceding block. This reduces the risk that any single party can tamper with existing blocks in the blockchain, as tampering with a block will alter its hash value. When receiving a proposed blockchain update from the tampering party, other computing devices detect the hash value mismatch and reject the change.

Counterfeit products represent a serious problem for the global manufacturing industry. Because there are often one or more intermediaries (e.g., shippers, suppliers, resellers) between a customer and the source of any particular product (e.g., the manufacturer), confidently tracing the product's provenance can be challenging. Use of counterfeit products can have significant consequences—for instance, when integrated into machines or vehicles, counterfeit parts can result in unexpected errors or failures that are difficult to investigate. As such, many companies spend significant time and financial resources testing the physical parts that they purchase to determine whether the parts are authentic.

### SUMMARY

This summary is not an extensive overview of the specification. It is intended to neither identify key or critical elements of the specification nor delineate any scope particular to embodiments of the specification, or any scope of the claims. Its sole purpose is to present some concepts of the specification in a simplified form as a prelude to the more detailed description that is presented in this disclosure.

A method for automatic product authenticity verification includes, at an authentication computing system, computer-recognizing one or more observed identifying parameters of a candidate physical product, the candidate physical product associated with a product identifier. The authentication computing system computer-identifies a block of a digital blockchain referencing the product identifier, the block including one or more recorded identifying parameters for a genuine physical product. An authenticity of the candidate physical product is computer-evaluated by automatically comparing the one or more observed identifying parameters of the candidate physical product to the one or more recorded identifying parameters for the genuine physical product.

The features, functions, and advantages that have been discussed can be achieved independently in various embodiments or can be combined in yet other embodiments, further details of which can be seen with reference to the following description and drawings.

### BRIEF DESCRIPTION OF THE DRAWINGS

FIG. 1 schematically illustrates parties in a supply chain involved in transporting physical products from a source party to a recipient party.

FIG. 2 illustrates an example method for automated product authenticity verification.

FIGS. 3A and 3B schematically illustrate recognizing identifying parameters for candidate physical products.

FIGS. 4A and 4B schematically illustrate the use of identifying marks on a candidate physical product as an identifying parameter.

FIG. 5 schematically illustrates a plurality of computing devices cooperatively maintaining a digital blockchain.

FIG. 6 schematically depicts different types of data included in an example digital blockchain.

FIG. 7 schematically illustrates an automated comparison between observed identifying parameters and recorded identifying parameters.

FIG. 8 schematically shows an example computing system.

### DETAILED DESCRIPTION

Evaluating the authenticity of physical products is often expensive and time consuming. The difficulty in detecting counterfeit products increases significantly when large quantities of different products are received that originate from multiple different sources (e.g., manufacturers), and travel through multiple different supply chain layers (e.g., shippers, suppliers, resellers). As non-limiting examples, vehicles such as aircraft, automobiles, watercraft, spacecraft, etc., include a wide variety of different physical parts that often traverse a large and complicated supply chain before being integrated into the vehicle, making counterfeit parts especially challenging to detect. However, counterfeiting of physical products affects a number of different industries, and can potentially impact human health and safety when counterfeit parts go undetected. As such, the techniques described herein need not be limited solely to vehicle manufacturing.

The present disclosure is directed to techniques for automated authentication of physical products through the use of a digital blockchain. When a genuine physical product is produced by a source party (e.g., manufacturer), the source party adds a record to the digital blockchain that includes one or more different identifying parameters for the genuine physical product. These can include, as examples, the color, material composition, weight, and/or size of the physical product, presence of distinct markings (e.g., microscopic etchings) on the physical product, and/or other suitable characteristics usable for distinguishing a genuine product from a counterfeit. In some examples, these identifying parameters are hidden (e.g., using encryption) from parties other than the intended recipient of the physical product, reducing the risk that bad actors could attempt to create counterfeits imitating the identifying parameters of the genuine product.

The recipient receives a physical product that ostensibly is a genuine physical product, but the provenance of the received product is not completely trusted. For instance, it is possible that a bad actor along the supply chain could have introduced a counterfeit product that is passed off to the recipient as genuine. The physical product received by the recipient is described herein as a “candidate physical product.” The recipient collects a set of one or more observed identifying characteristics for the candidate physical product, which are compared to the identifying characteristics for the genuine physical product that were added to the blockchain by the source party. Due to the nature of blockchain technology, the recipient can be confident that the identifying parameters for the genuine product have not been tampered with. If the observed identifying parameters of the candidate physical product match the recorded identifying parameters of the genuine physical product to within a similarity threshold, then the candidate physical product is determined to be genuine. Conversely, in some cases, the observed and recorded parameters do not match, and the candidate physical product is determined not to be authentic.

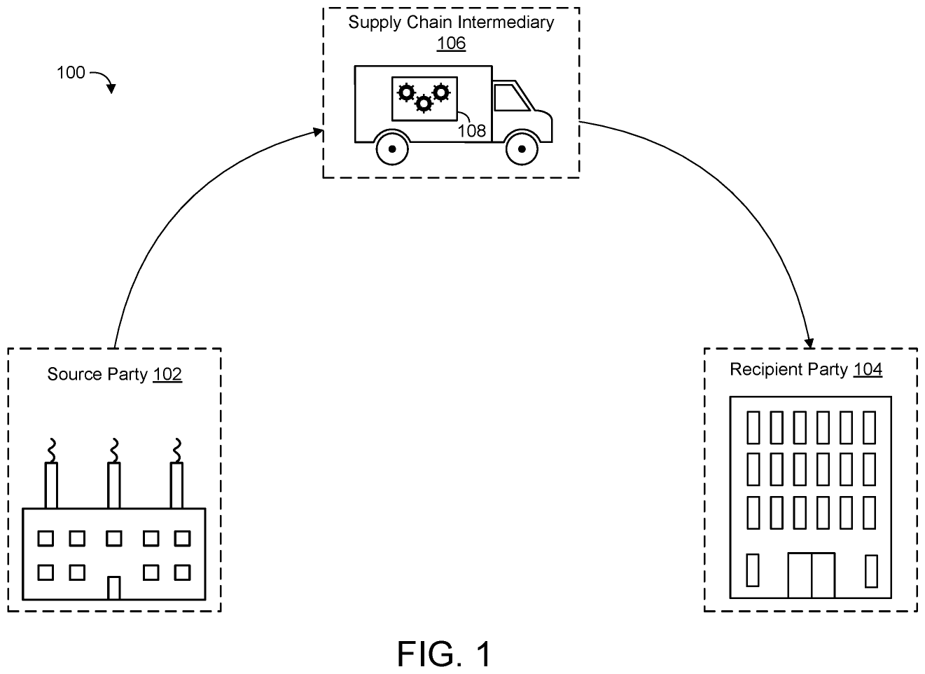

FIG. 1 provides a simplified schematic representation of a supply chain 100. As shown, in this simplified example, supply chain 100 includes a source party 102, a recipient party 104, and a supply chain intermediary 106. The source party has produced a physical product 108, which in this example, is transported by the supply chain intermediary from the source party to the recipient party. A “physical product” as used herein may refer to any physical device, mechanism, component, subcomponent, or other physical object that is produced by one party (e.g., a manufacturer) and received by a recipient (e.g., customer). Counterfeiting affects a wide range of goods across many industries, and thus it will be understood that the techniques described herein are applicable to a wide range of different physical products.

Because the physical product takes a wide variety of suitable forms, it will be understood that the various parties involved in the supply chain also take a wide variety of suitable forms depending on the implementation. In general, the “source party” is an entity (e.g., company, organization, individual) that originally produces the physical product. This can include a manufacturer (e.g., original equipment manufacturer), assembler, fabricator, refiner, or other suitable party that produces the physical product. The physical product may be produced from raw materials, and/or assembled from one or more subcomponents that may in turn be sourced from one or more respective source parties.

The “recipient party” refers to an intended recipient of the physical product, which in some cases is a customer that purchased the physical product from the source party. As with the source party, the recipient party can refer to any entity (e.g., company, organization, individual) that receives a physical product purportedly originating from the source party. It will be understood that the physical product need not always be received as part of a commercial transaction. For instance, in some examples, the recipient party may be an inspector, auditor, or regulator, the recipient party may receive the physical product as a gift or donation, etc.

Similarly, there may be any number and variety of supply chain intermediaries between the source party and recipient party, any or all of which may be involved in moving physical products from the source party to the recipient party. These can include parties that transport, distribute, and/or temporarily store the physical product. For instance, supply chain intermediaries can include shippers (e.g., parties that transport the physical product from one point to another), resellers, storage depots, etc. Though only one supply chain intermediary is shown in FIG. 1, it will be understood that this is non-limiting.

As discussed above, it can be difficult for the recipient party to completely trust that any particular physical product it receives is a genuine physical product produced by the source party, and not a counterfeit or other imitation. Using the example of FIG. 1, it can be difficult for recipient party 104 to trust that the physical product it receives from supply chain intermediary 106 is the same product produced by source party 102. Some organizations spend significant time and financial resources manually inspecting and tracing the physical products they purchase to improve detection of counterfeits.

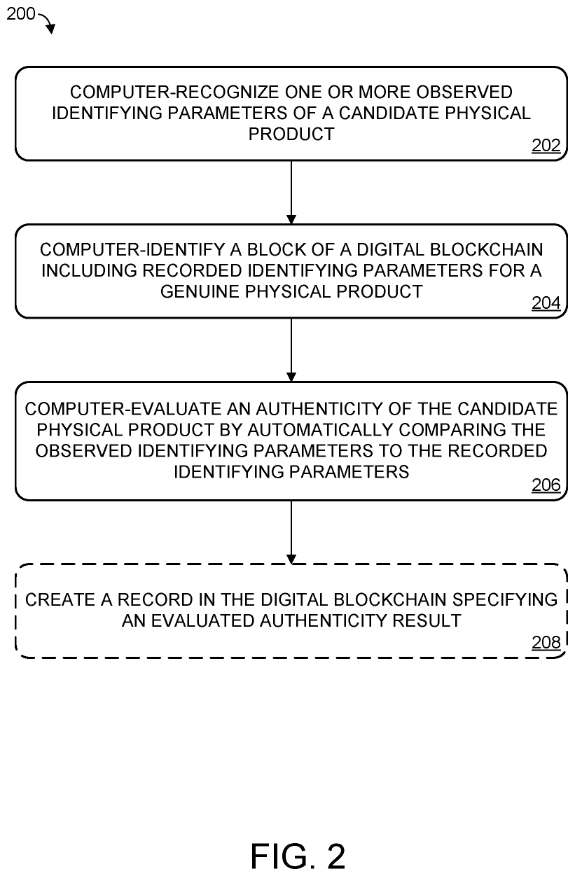

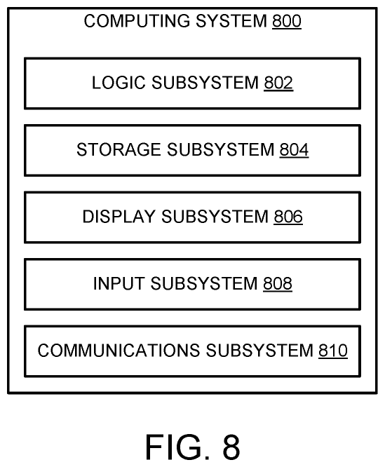

Accordingly, FIG. 2 illustrates an example method 200 for automated product authenticity verification. Method 200 is primarily described as being performed by an “authentication computing system” associated with a recipient party that receives a physical product. For instance, the authentication computing system may include one or more on-premises computing devices owned or otherwise accessible to the recipient party. Additionally, or alternatively, the authentication computing system may be partially or entirely implemented by a cloud computing service accessible to the recipient party. More generally, the “authentication computing system” used to implement steps of method 200 may be implemented by any suitable computing system of one or more computing devices. A computing device implementing steps of method 200 may have any suitable capabilities, form factor, and hardware configuration. Steps of method 200 may be initiated, terminated, and/or looped at any suitable time and in response to any suitable condition. In some examples, any or all steps of method 200 may be implemented through execution of a smart contract of a digital blockchain, as will be described in more detail below. In some examples, one or more computing devices used to perform steps of method 200 are implemented as computing system 800 described below with respect to FIG. 8.

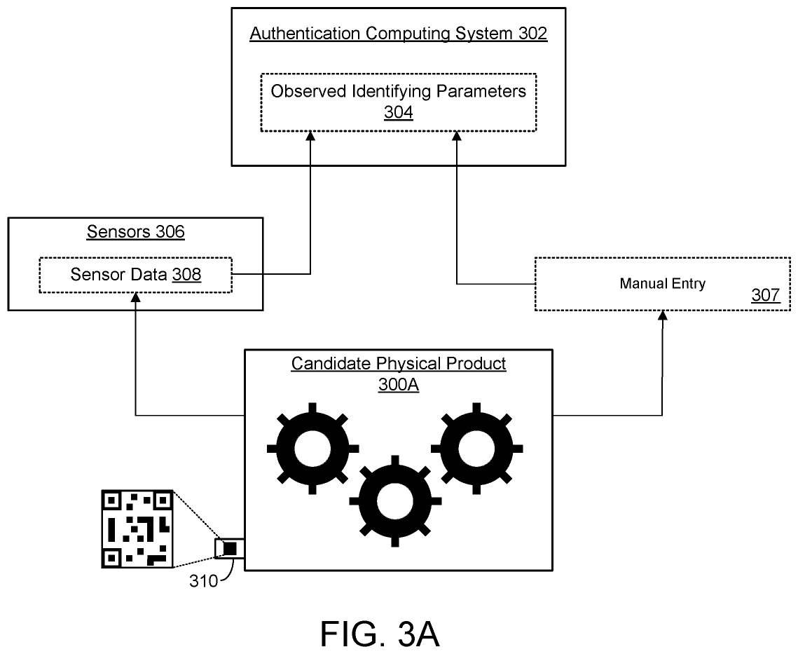

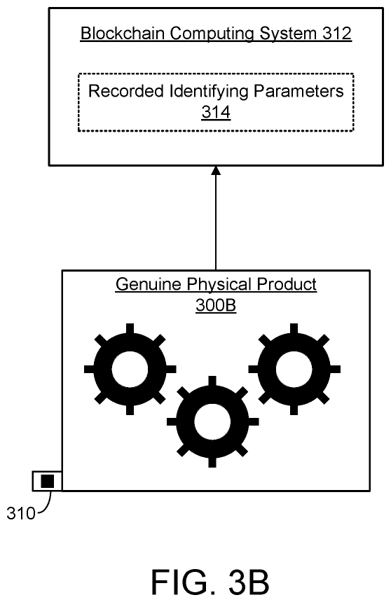

At 202, method 200 includes, at an authentication computing system, computer-recognizing one or more observed identifying parameters of a candidate physical product. This is schematically illustrated with respect to FIG. 3A, showing an example candidate physical product 300A. It will be understood that the candidate physical product 300A shown in FIG. 3A is a generic representation and that, as discussed above, a “physical product” can take a wide variety of suitable forms depending on the implementation. Furthermore, as discussed above, a “candidate” physical product refers to a product received by the receiving party, that is ostensibly a genuine physical product originating from the source party, but could potentially be a counterfeit.

In order to verify the authenticity of the candidate physical product, the receiving party collects a set of one or more identifying parameters of the candidate physical product. These are referred to herein as “observed” identifying parameters, as they are observed by the receiving party upon receipt of the candidate physical product. Notably, “observed” parameters can include those that are visible to the human eye, and/or parameters that are observable through the use of suitable sensors or tools. In the example of FIG. 3A, an authentication computing system 302 recognizes a set of observed identifying parameters 304. As used herein, “recognizing” or “computer-recognizing” refers to one or more computing devices loading the identifying parameters (e.g., expressed as digital computer data) into volatile or non-volatile data storage, such that one or more processing operations may be applied to the observed identifying parameters. As will be described in more detail below, these processing operations may include comparing the observed identifying parameters to a different set of identifying parameters known to correspond to a genuine physical product. In some examples, “computer-recognizing” the observed identifying parameters includes storing the observed identifying parameters using storage subsystem 804 described below with respect to FIG. 8.

As used herein, an “identifying parameter” refers to any suitable observable characteristic of a physical product that could potentially be used to distinguish a genuine product from a counterfeit. Observable parameters may include those observable to the naked human eye, and/or parameters only observable through the use of suitable tools and/or sensors. These can include, as examples, a weight of the candidate physical product, measured dimensions of the candidate physical product, a color of the candidate physical product (e.g., expressed as an RGB color value), a material composition of the candidate physical product, a paint composition of the candidate physical product, a placement of one or more identifying marks on the candidate physical product (e.g., printed marks, etchings, watermarks), radio frequency (RF) and/or electromagnetic (EM) characteristics of the physical product, etc. It will be understood that this list is not exhaustive, and due to the wide variety of different types of physical products that can be counterfeited, a wide variety of different identifying parameters could potentially be observed while verifying the authenticity of any particular product.

The observed identifying parameters are collected in any suitable way. In some examples, computer-recognizing the one or more observed identifying parameters includes quantifying the one or more observed identifying parameters based on sensor data output by one or more sensors of the authentication computing system. In the example of FIG. 3A, at least some of the observed identifying parameters 304 are quantified by a set of one or more sensors 306, which collect sensor data 308.

Any suitable input sensors may be used. As non-limiting examples, the sensors may include cameras (e.g., visible light cameras, depth cameras, infrared cameras), mass/weight sensors (e.g., scales), size measurement devices (e.g., calipers), thermal sensors, radio frequency detectors, acoustic sensors, magnetic field sensors (e.g., magnetometers), electrical monitoring sensors (multimeters), chemistry-based sensors (e.g., spectrometers, pH meters, moisture detectors), etc.

Depending on the specific identifying parameters being measured, an “identifying parameter” may take the form of the unmodified data output by a sensor (e.g., a weight measurement output by a scale), and/or one or more processing operations may be applied to the sensor data to derive the identifying parameter. For instance, image processing operations (e.g., feature recognition, computer vision) may be applied to the image data output by a camera to derive an identifying parameter, such as the position of a particular feature or marking on the physical product.

As discussed above, in some cases the identifying parameters collected for a physical product may include one or more identifying marks on the physical product—e.g., printed or etched onto a surface of the product. Such identifying marks may have any suitable size and appearance. In some examples, the identifying marks have a small size that is difficult or impossible to detect with the human eye—e.g., the identifying marks may be microscopic.

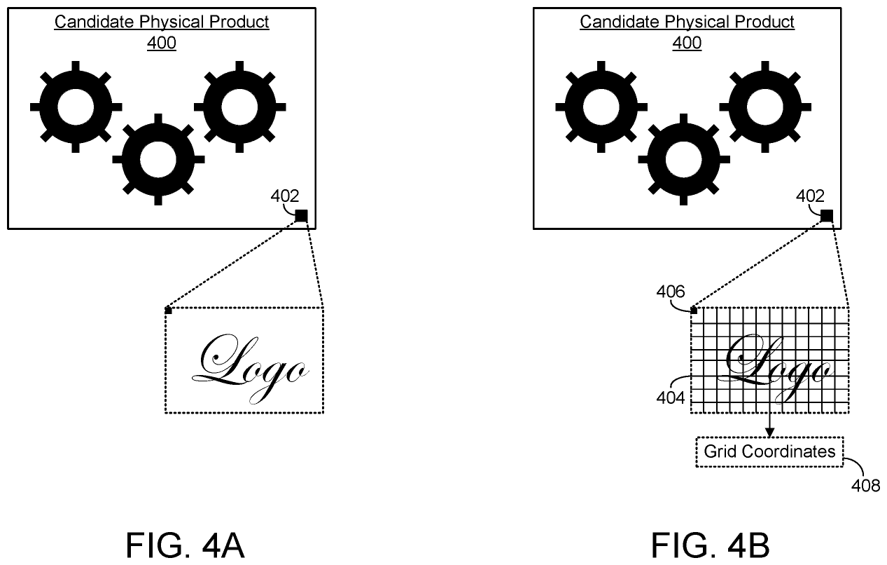

The appearance of an identifying mark may be quantized in any suitable way so as to enable comparison between similar marks (or the same exact mark) present on a candidate physical product and a genuine physical product. One non-limiting scenario is schematically illustrated with respect to FIGS. 4A and 4B. Specifically, FIG. 4A shows a candidate physical product 400, which includes an example identifying mark 402 taking the form of small text spelling the word “logo.” In this example, computer-recognizing one or more observed parameters at the authentication computing system includes defining a virtual grid relative to a predefined reference point on the candidate physical product. The authentication computing system then recognizes grid coordinates of the virtual grid occupied by the one or more identifying marks.

This is schematically illustrated with respect to FIG. 4B, again showing candidate physical product 400 and identifying mark 402. In this example, a virtual grid 404 has been defined relative to a predefined reference point 406 on the candidate physical object. As shown, aspects of the identifying mark are present within some grid cells of the virtual grid, while other grid cells are empty. The specific coordinates of the occupied grid cells (defined relative to any suitable grid coordinate system) serve as a form of fingerprint of the identifying mark. Even small differences in size and/or position between a genuine identifying mark and a counterfeit mark may change the specific grid cells that are occupied by the identifying mark. As such, in the example of FIG. 4B, the observed identifying parameters include grid coordinates 408 of grid cells occupied by the identifying mark.

It will be understood that the virtual grid and predefined reference point take any suitable form. The predefined reference point may be any suitable facet, feature, or arbitrary point on the candidate physical product (e.g., the corner of the product, a specific point at a measured distance away from the sides of the product, a label applied to the product), provided that the position of the predefined reference point is known to both the source and recipient parties. Similarly, the virtual grid may have any suitable size and resolution, provided that it is consistently applied by both the source and recipient parties.

Regardless, in some cases, the observed identifying parameters are provided to the authentication system automatically, with no need for a human worker to manually enter the identifying parameters. For instance, the sensors may be communicatively coupled with the authentication computing system, such that sensor data and/or identifying parameters output by the sensors are automatically transmitted to the authentication computing system. Additionally, or alternatively, at least some observed identifying parameters may be provided to the authentication computing system by a human worker—e.g., as shown in FIG. 3A, at least some parameters may be entered via manual entry 307. For instance, the human worker may apply one or more digital sensors and/or manual tools to the candidate physical product to collect identifying parameters of the candidate physical product, and/or data usable to derive the identifying parameters. The human worker may then provide such information to the authentication computing system using any suitable input modality—e.g., using input subsystem 808 described below with respect to FIG. 8.

In general, there may be varying degrees of human involvement in the collection of identifying parameters depending on the implementation. In one example, the observed identifying parameters for the candidate physical object are collected partially or entirely through a human worker using one or more tools and/or electronic sensors to measure aspects of the candidate physical worker, which are then provided to the authentication computing system automatically and/or through manual input. As another example, the candidate physical product may be placed along an automated inspection line, where a conveyor belt moves the candidate past a set of one or more sensors that automatically collect and report sensor data to the authentication computing system, with little to no direct human involvement.

According to the techniques described herein, the candidate physical product is associated with a product identifier. This is an identifier assigned to the genuine physical product after it is produced by the source party. The candidate physical product is associated with the same product identifier either because it is genuine, or because a counterfeiter recreated the product identifier.

The product identifier is typically printed on, or otherwise attached to, the candidate physical product itself and/or packaging of the candidate physical product, although this need not always be the case. As non-limiting examples, the product identifier may be printed or etched directly onto the candidate physical product, specified by a physical tag attached to the candidate physical product, specified by packaging of the candidate physical product, specified by documentation received with the candidate physical product (e.g., a manual, shipping manifest, sales contract), and/or communicated from the source party directly to the receiving party (e.g., through a physical and/or electronic communication).

In the example of FIG. 3A, the candidate physical product has a physical tag 310 attached, which specifies the product identifier. The product identifier may be expressed or encoded in any suitable way. In the non-limiting example of FIG. 3A, the product identifier is expressed using a QR code. It will be understood that other types of data may be specified using a physical tag (and/or otherwise associated with the candidate physical product) in addition to, or instead of, the product identifier. As another example, the printed tag may specify a blockchain address of a block in a digital blockchain in which identifying parameters are recorded for a genuine physical product.

In some examples, the product identifier is assertedly a unique product identifier that was assigned by the source party to a genuine physical product, and should in theory not be used by any other physical products produced by the source party. However, it is possible that a counterfeiter could have created an imitation of the genuine physical product that recreates the unique product identifier, and thus two or more unique items may exist that have the same “unique” identifier, while only one such item is genuine. In other examples, the product identifier need not be intended as a “unique” product identifier, but rather may be a model name, batch number, order number, or other similar identifier that refers to a class or type of physical product without referring to one specific item. As such, presence of a product identifier on the candidate physical product is not a guarantee of authenticity (however, absence of a product identifier on the candidate physical product may be a sign that the product is not authentic).

Given this, the product identifier is not intended to serve as a sign of the candidate product identifier's authenticity, but rather as a way to retrieve recorded identifying parameters known to correspond to a genuine physical product originating from the source party. In other words, upon producing the genuine physical product, the source party assigns the product identifier to the genuine physical product. The source party then collects and records “recorded” identifying parameters for the genuine physical product in a digital blockchain in tandem with the product identifier, as will be described in more detail below. The receiving party uses the product identifier to find these recorded identifying parameters, which are compared to the observed identifying parameters to evaluate the authenticity of the candidate physical product.

The process of collecting recorded identifying parameters for a genuine physical product is schematically illustrated with respect to FIG. 3B. Specifically, FIG. 3B shows a genuine physical product 300B. It will be understood that the recorded identifying parameters for the genuine product are collected before the recipient party receives the candidate physical product and collects the observed identifying parameters. In other words, the process schematically illustrated in FIG. 3B takes place chronologically before the process schematically illustrated in FIG. 3A, such that the receiving party collects the observed identifying parameters, and then compares them to the recorded identifying parameters previously recorded for the genuine physical product.

In some cases, it is intended that the genuine physical product for which the recorded identifying parameters are collected is the same unique item as the candidate physical product later received by the receiving part. In other examples, the recorded identifying parameters are applicable to more than one different genuine physical product—e.g., they may be usable to evaluate the authenticity of any genuine physical products of the same model or type. As such, in some cases, the genuine physical product is the same unique item as the candidate physical product later received by the receiving party. In some cases, the candidate physical product is actually different from the specific genuine product for which the recorded identifying parameters are collected, but the received candidate product is still a genuine product originating from the source party. Furthermore, regardless of whether it is intended that the genuine and candidate physical products are the same unique item, the candidate physical product received by the receiving party may in some cases be a counterfeit item.

In FIG. 3B, a blockchain computing system 312 stores recorded identifying parameters 314. As used herein, a “blockchain computing device” refers to any suitable computing device that maintains, and/or has access to, a digital blockchain. In some examples, a blockchain computing device is implemented as computing system 800 described below with respect to FIG. 8.

As with the observed identifying parameters described above, the recorded identifying parameters collected by the source party may be collected and provided to the blockchain computing system in any suitable way, using any suitable combination of automation and/or manual work. Furthermore, the specific manner in which the recorded identifying parameters are collected may in some cases differ from the specific manner in which the observed identifying parameters are collected by the recipient party (e.g., the number and types of different sensors, the division between manual vs automated work). Notably, as will be described in more detail below, the authenticity of the candidate physical product is evaluated by comparing the observed identifying parameters to the recorded identifying parameters, and thus the methods used to collect each set of identifying parameters are beneficially consistent and replicable. In other words, regardless of the specific manner in which the source and recipient parties collect the respective recorded and observed identifying parameters, the two parties should record substantially similar results for the same unique item, even if the two parties do not use the same or similar workflows to obtain their results.

Furthermore, because the recorded and observed identifying parameters are compared to evaluate the authenticity of the candidate physical product, the observed and identifying parameters typically include similar types of data to enable the comparison. For instance, if the recorded identifying parameters include a weight of the genuine physical product, then the observed identifying parameters will likely include a weight of the candidate physical product, such that the two weights can be compared. However, in some cases, the recorded identifying parameters may include one or more types of data that are not collected by the recipient party, and/or vice versa. For instance, even if the recorded identifying parameters do include the weight of the genuine physical product, this does not require that the observed identifying parameters must also include the weight of the candidate physical product. Rather, the receiving party may opt not to weigh the candidate physical product if it is believed that the authenticity of the candidate physical product can be sufficiently evaluated based on other identifying parameters besides weight.

In any case, once the source party collects identifying parameters for the genuine physical product, the identifying parameters are recorded in a digital blockchain as recorded identifying parameters. Using blockchain, various types of computer data (e.g., identifying parameters for physical products) are recorded in a distributed ledger that is collectively maintained by a large number of networked computing devices. Because the blockchain is redundantly stored on many devices, tampering with or deletion of any particular copy of the blockchain should not affect the blockchain as a whole, as other computing devices maintaining the blockchain will reject the change. Only valid, authorized blocks are approved and added to the chain. This alleviates the need for a central institution, such as a government, auditor, or service provider, to serve as a solitary trusted recordkeeper.

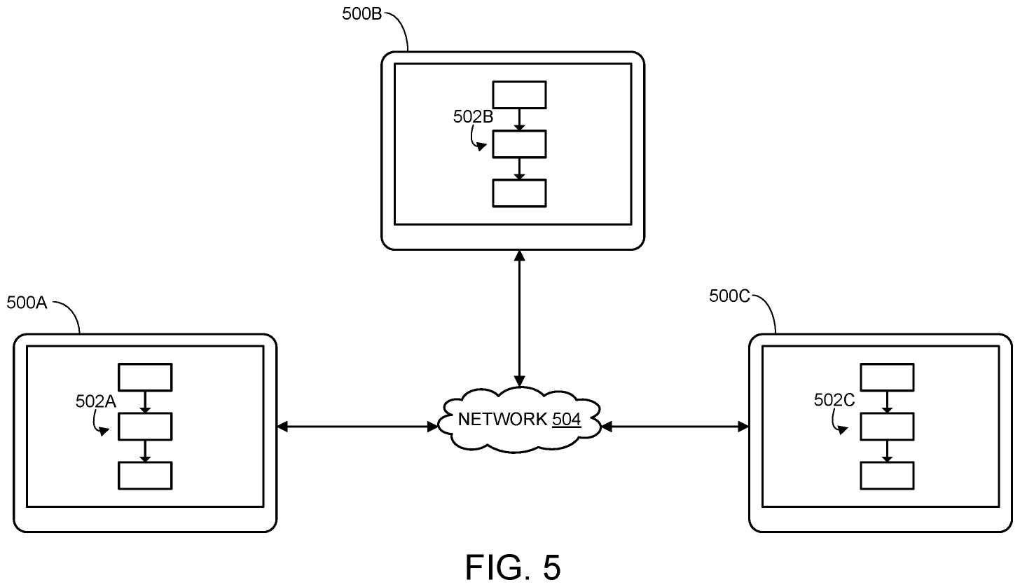

FIG. 5 schematically illustrates a plurality of computing devices 500A, 500B, and 500C collectively maintaining a blockchain 502 over a network 504. As shown, each individual computing device maintains its own corresponding local copy 502A-C of the blockchain. Each computing device includes a suitable communications interface used to communicatively couple the plurality of computing devices over the network. It will be understood that a computing device used to maintain a blockchain may have any suitable capabilities, hardware configuration, and form factor. As examples, a suitable computing device may take the form of a server computer, desktop computer, laptop, etc. In some examples, the computing devices 500A-C may be implemented as any or all of the computing devices described above—e.g., computing devices 500A-C cooperatively maintaining the digital blockchain may include the authentication computing system and a blockchain computing system associated with the source party. In some examples, computing devices 500A-500C may be implemented as computing system 800 described below with respect to FIG. 8.

Only three computing devices are shown in FIG. 5. However, this is for illustration purposes only. In practical usage, a blockchain may be collectively maintained by any number and variety of computing devices. Such computing devices may be separated by any physical distance and may communicate over any suitable network, including private networks, public networks such as, for example, the Internet, and/or hybrid network environments.

Furthermore, the computing devices may be owned and maintained by any number of different individuals or organizations. The present disclosure primarily focuses on scenarios where access to the blockchain is restricted to known users or parties (e.g., those involved in the supply chain for a receiving party), in which case the blockchain may be referred to as a “private blockchain.” Alternatively, in some examples, the blockchain may be publicly accessible, in which substantially anyone can download and maintain a local copy of the blockchain.

Depending on the implementation, devices maintaining the blockchain may use any suitable method to validate the identity of a party submitting a new block. In general, when the blockchain is distributed between two or more different devices, tampering with any particular copy of the blockchain should not affect the blockchain as a whole, as other computing devices maintaining the blockchain will reject the change. Only valid, authorized blocks are approved and added to the chain. For example, each party authorized to contribute to the blockchain may be assigned a unique digital signature, which can be validated upon receiving a new block—e.g., via private key/public key cryptography.

Because the blockchain is collectively maintained by the plurality of computing devices, each local copy of the blockchain should be substantially identical in typical usage. When any particular computing device determines that the blockchain should be changed (e.g., by adding recorded identifying parameters for a genuine physical product), it transmits a proposed update to the other computing devices in the plurality. Depending on the implementation, this proposed update may take a variety of suitable forms, and may be evaluated for compliance by other computing devices of the plurality before incorporation into the blockchain. Assuming the proposed update is compliant, the other computing devices of the plurality incorporate the proposed update into their local copies of the blockchain, meaning each local copy will continue to be substantially identical. If the proposed update is non-compliant (e.g., because it includes fraudulent information), then the other computing devices may reject its addition to the blockchain. In this manner, each party associated with the blockchain can be confident that any particular copy of the blockchain they access will reflect an overall consensus.

In any case, the source party records the recorded identifying parameters in the digital blockchain in any suitable way, depending on the specific implementation. The recorded identifying parameters are encoded within the blockchain using any suitable encoding and/or encryption. For instance, in some examples, the recorded identifying parameters are encoded as events, transactions, and/or other suitable data in a block of the digital blockchain.

Furthermore, in some examples, the one or more recorded identifying parameters are encrypted in the block of the digital blockchain. This can beneficially restrict visibility of the recorded identifying parameters only to parties authorized to view the parameters by the source party. For instance, while various entities involved in the supply chain may have access to the digital blockchain, knowledge of an encryption key, password, or other encryption-related information may be withheld from parties other than the source party and recipient party. In this manner, the recipient party is able to retrieve and decrypt the recorded identifying parameters from the blockchain, while potential counterfeiters are unable to view the unencrypted identifying parameters. This can make it more difficult for bad actors to produce convincing counterfeit products, as they are unaware of the specific identifying parameters used by the receiving party to distinguish between genuine products and counterfeits. Any suitable encryption scheme may be used, depending on the degree of security and convenience desired by the source and recipient parties.

Furthermore, it will be understood that the recorded identifying parameters are not the only type of data recorded by the source party in the digital blockchain. The source party additionally records the product identifier of the genuine physical product in the digital blockchain, associated with the recorded identifying parameters of the genuine physical product. In this manner, once the receiving party receives the candidate physical product, the product identifier can be used to identify the recorded identifying parameters in the blockchain by finding a block that specifies the product identifier.

In any case, once the recorded identifying parameters are recorded in the blockchain, they are accessible to the recipient party. As such, returning briefly to FIG. 2, at 204, method 200 includes computer-identifying a block of a digital blockchain that references the product identifier associated with the candidate physical product, and includes the one or more recorded identifying parameters for the genuine physical product. As discussed above, the recorded identifying parameters are previously provided to the digital blockchain by the source party that produced the genuine physical product.

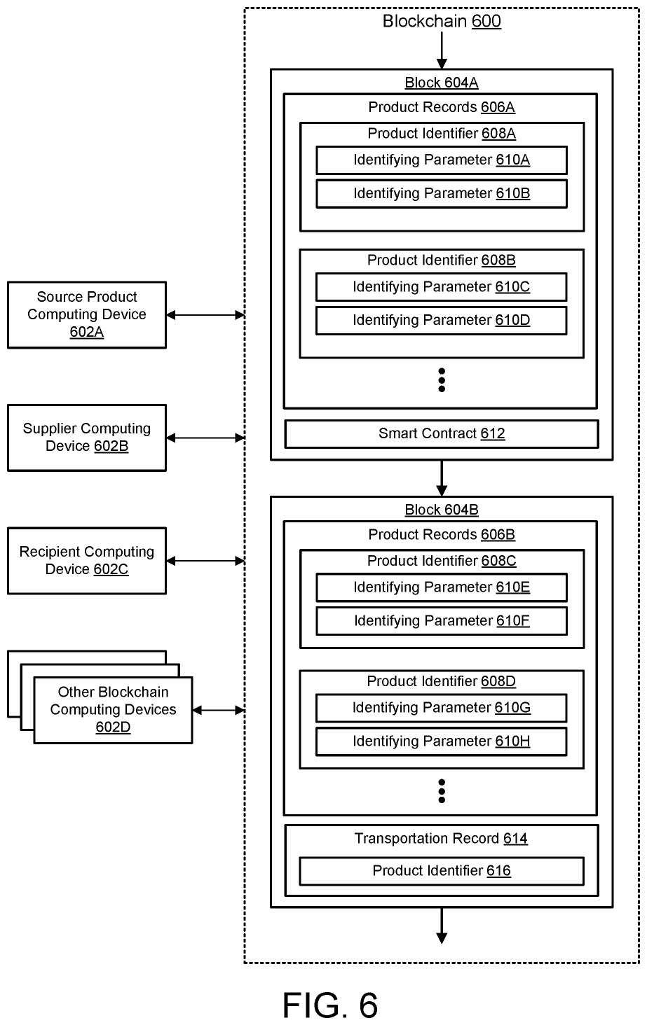

FIG. 6 schematically shows an example blockchain 600 in more detail. The blockchain is accessible to a plurality of computing devices 602A-D. In this example, the computing devices include a source party computing device 602A, a supplier computing device 602B, a recipient computing device (e.g., an authentication computing system), and one or more other blockchain computing devices 602D. Any or all of these computing devices may maintain their own local copies of the blockchain, and coordinate with one another to update their local copies as new blocks are added.

As shown, blockchain 600 includes a plurality of blocks, including two blocks labeled as 604A and 604B. It will be understood that a blockchain may include any arbitrary number of blocks. Depending on the implementation, each block in the blockchain can include a wide variety of suitable information. In typical scenarios, each block will include a header and a listing of transactions, events, or other data entries. A block header often includes a hash of the previous block in the chain. A hash can be described as a unique “fingerprint” of a piece of digital information and can be calculated using a variety of suitable hashing algorithms, including MD5 and SHA-256 as nonlimiting examples. Inclusion of prior block hashes serves to validate the sequence of blocks in the blockchain, as each block should be succeeded by a block including a corresponding hash value, and also provides a defense against modifications to the chain, as even minor changes to a block will affect its hash value. In some cases, each block may utilize a corresponding “proof-of-work” or “proof-of-stake” paradigm for authentication and consensus.

Additionally, or alternatively, a block header may include some representation of the transactions or events recorded in the block. For example, in some blockchain implementations, each block includes a Merkle tree that summarizes the transactions or events recorded in the block. This can serve as another indicator that the data found in the block has not been corrupted or tampered with.

In addition to a header, each block in a blockchain will typically include a list of transactions, events, or other relevant data entries. The present disclosure primarily focuses on implementations where the data entries include information pertaining to physical products—e.g., product identifiers, identifying parameters, timestamps, and/or order numbers. Other blockchain implementations may record other types of data in each block. Though not specifically shown in FIG. 6, each block in the blockchain may be associated with one or more timestamps. For instance, each block may include a timestamp indicating the time at which the block was created. Additionally, or alternatively, one or more records within the block (e.g., sets of identifying parameters for physical products) may be associated with their own respective timestamps to indicate when the records were created.

In FIG. 6, the blockchain 600 includes recorded identifying parameters for a genuine physical product. Specifically, block 604A includes a set of product records 606A associated with a product identifier 608A. As discussed above, the product identifier is recorded in the digital blockchain along with the recorded identifying parameters to enable the authentication computing system associated with the receiving party to identify the recorded identifying parameters. For instance, the authentication computing system may search the blockchain for a block that references the product identifier, or an earliest block referencing the product identifier in cases where it is present in multiple blocks, to identify the recorded identifying parameters.

In FIG. 6, the product identifier 608A is associated with a set of identifying parameters, including identifying parameters 610A and 610B. As discussed above, these may quantify any suitable observable characteristics of the genuine physical product. Furthermore, the identifying parameters may be encoded and/or encrypted within the blockchain in any suitable way.

The present disclosure has primarily focused on recording identifying parameters for a single physical product. However, it will be understood that identifying parameters for a number of different physical products, originating from the same or different source parties, may be recorded in the digital blockchain. As such, in some examples, the same block of the digital blockchain may include two or more product identifiers, and sets of recorded identifying parameters corresponding to two or more other genuine physical products, produced by the same or different source parties. This is schematically illustrated in FIG. 6, where block 604A additionally includes a second product identifier 608B and associated identifying parameters 610C and 610D for a different genuine physical product. Similarly, block 604B includes a set of product records 608B, which in turn includes product identifiers 608C and 608D, respectively associated with recorded identifying parameters 610E/F, and 610G/H.

As discussed above, any or all of the techniques described herein may in some cases be implemented via execution of one or more smart contracts of the digital blockchain. In FIG. 6, block 604A of blockchain 600 defines a smart contract 612. A smart contract is a data structure that automatically performs certain actions when previously-specified events occur. For example, when predetermined conditions are met, a smart contract can perform transactions (e.g., reads and writes) that modify the state of the smart contract and/or trigger events that can be monitored by external entities. In some examples, any or all steps of method 200 described above with respect to FIG. 2 may be performed via execution of one or more smart contracts.

In more complicated scenarios, smart contracts may include any number of functions that can perform any number of actions when associated conditions are met. In general, a smart contract will have a state, which may, for example, define an agreement reached between two parties (e.g., purchase of a genuine physical product), as well as one or more functions, which may be implemented as if/then statements that perform actions when associated conditions are met. These functions may be defined in terms of variables, such that when one or more variables have previously specified values, a condition is satisfied and the function is triggered.

On a technical level, a smart contract may be implemented as computer code defined by one or more data entries within one or more blocks in a blockchain. Such computer code may be written in any suitable coding language, depending on the specific implementation. Because the blockchain is distributed between a plurality of computing devices, the computer code comprising the smart contract may run on any of the plurality of devices, or on all devices simultaneously. In a typical example, one or more devices of the plurality will receive some indication (e.g., the current state of a variable) that pertains to the smart contract, causing the smart contract to execute.

Though the present disclosure focuses on a scenario in which the smart contracts are stored and executed in blocks of a blockchain (i.e., “on-chain”), various “off-chain” scenarios are also within the scope of this disclosure. In other words, the smart contract may run and execute on a computing device that monitors the blockchain, although does not maintain a local copy. As one example, a dedicated computing system may store and execute the smart contract, as well as monitor conditions relevant to the smart contract—e.g., product authenticity.

It will be understood that the digital blockchain may include other types of suitable data in addition to recorded identifying parameters and associated product identifiers for physical products. Furthermore, parties other than the source party may in some cases record data in the digital blockchain. For instance, in FIG. 6, blockchain 600 includes a transportation record 614 that specifies a product identifier 616. This may, for instance, be recorded in the blockchain by a supplier in the extended supply chain that was involved in transporting the physical product from the source party to the receiving party. The transportation record may include any suitable information, such as the product identifier, a timestamp, an order number, invoice number, contract number, confirmation code of successful delivery, arbitrary notes, etc.

Furthermore, due to the nature of blockchain technology, the transportation record cannot be tampered with by any party maintaining the blockchain. In this manner, recording transportation records and/or other supply chain-related records in the blockchain can beneficially be used to create a trusted and secure chain of custody for a physical product associated with a particular identifier. In this manner, should the receiving party determine that a candidate physical product is not authentic, the receiving party can investigate records submitted to the blockchain to determine which other parties had access to the physical product, and attempt to determine where the counterfeit was introduced.

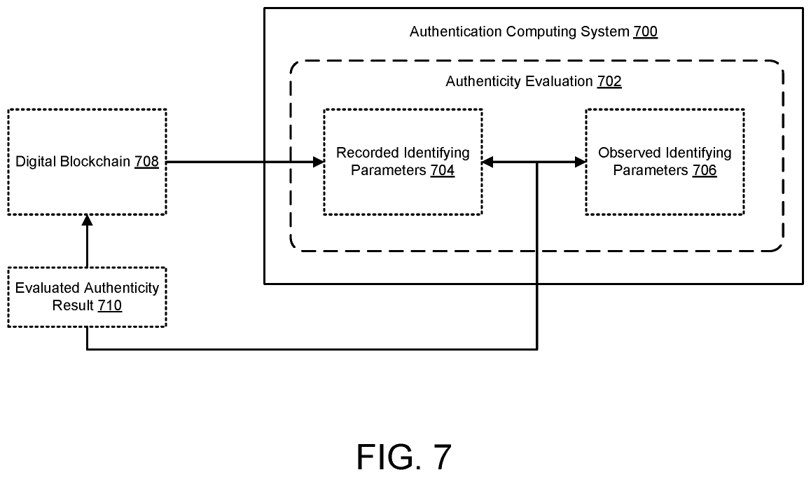

Returning briefly to FIG. 2, at 206, method 200 includes computer-evaluating an authenticity of the candidate physical product by automatically comparing the one or more observed identifying parameters of the candidate physical product to the one or more recorded identifying parameters for the genuine physical product. This is schematically illustrated with respect to FIG. 7, showing an example authentication computing system 700. The authentication computing system performs an authenticity evaluation operation 702, in which a set of recorded identifying parameters 704 are compared to a set of observed identifying parameters 706. The recorded identifying parameters are retrieved from a digital blockchain 708 as described above. The observed identifying parameters are collected via any suitable observation or measurement of a candidate physical product, as described above with respect to FIG. 3A.

The specific manner in which the recorded and observed identifying parameters are compared to one another depends on the specific measurements, readings, or other data expressed by the identifying parameters. As one non-limiting example, each set of identifying parameters may be expressed as a multi-dimensional vector, where each individual identifying parameter serves as the value for the vector in a different dimension. The recorded and observed identifying parameters may then be compared by comparing their corresponding vector representations using any suitable vector comparison technique—e.g., by finding the cosine similarity between the two vectors. It will be understood that a wide variety of suitable different techniques may be used to quantify the relative similarity between two vectors or other sets of data, and any such technique may be used.

In any case, the comparison between the recorded and observed identifying parameters results in a value that expresses the relative similarity between the different sets of parameters. The specific form and scale of this value depends on the types of identifying parameters used, and the specific manner used to compare the identifying parameters. In any case, the similarity value may be compared to a similarity threshold to assess whether the candidate physical product is genuine or not. As with the similarity value, the similarity threshold takes any suitable form depending on the implementation, and may be determined by the source party on a case-by-case basis to balance the risk of false positives vs the risk of false negatives.

In other words, in one example, computer-evaluating the authenticity of the candidate physical product includes, based on determining that the one or more observed identifying parameters match the one or more recorded identifying parameters to within a similarity threshold, validating the candidate physical product as the genuine physical product. In other cases, computer-evaluating the authenticity of the candidate physical product includes, based on determining that the one or more observed identifying parameters do not match the one or more recorded identifying parameters to within the similarity threshold, rejecting the candidate physical product as an inauthentic counterfeit of the genuine physical product.

Regardless, after comparing the recorded and observed identifying parameters, the authentication computing system outputs an evaluated authenticity result. In FIG. 7, the authentication computing system 700 outputs an evaluated authenticity result 710. This may take any suitable form depending on the implementation. As non-limiting examples, the evaluated authenticity result may include an indication of whether the candidate physical product was determined to be authentic (e.g., yes or no), the similarity value obtained by comparing the sets of identifying parameters, a difference between the similarity value and the similarity threshold, the observed and/or recorded identifying parameters, differences between the observed and recorded identifying parameters, etc.

Returning briefly to FIG. 2, at 208, method 200 optionally includes creating a record in the digital blockchain specifying the evaluated authenticity result for the candidate physical product. In some examples, the record is automatically created in the digital blockchain via execution of a smart contract of the digital blockchain, as described above. In FIG. 7, the evaluated authenticity result 710 is recorded in blockchain 708.

In this manner, the authenticity of the product received by the receiving party may be recorded in the digital blockchain such that it is visible to other parties involved in the supply chain. For instance, in this manner, the blockchain may serve as a record of the reliability or trustworthiness of different supply chain intermediaries—e.g., it may become apparent that a particular supplier has a higher-than-normal rate of supplying counterfeit parts. This may lead the receiving party, source party, and/or other supply chain parties to change or terminate their relationship with the unreliable supplier. In some cases, such changes may be automatically implemented through execution of smart contracts—e.g., a smart contract may automatically terminate a business contract between two parties in response to detecting, based on records in the blockchain, that a particular party is not fulfilling its contractual obligations (e.g., due to excessive delivery of counterfeit parts).

The methods and processes described herein may be tied to a computing system of one or more computing devices. In particular, such methods and processes may be implemented as an executable computer-application program, a network-accessible computing service, an application-programming interface (API), a library, or a combination of the above and/or other compute resources.

FIG. 8 schematically shows a simplified representation of a computing system 800 configured to provide any to all of the compute functionality described herein. Computing system 800 may take the form of one or more network-accessible devices, personal computers, server computers, mobile computing devices, and/or other computing devices.

Computing system 800 includes a logic subsystem 802 and a storage subsystem 804. Computing system 800 may optionally include a display subsystem 806, input subsystem 808, communication subsystem 810, and/or other subsystems not shown in FIG. 8.

Logic subsystem 802 includes one or more physical devices configured to execute instructions. For example, the logic subsystem may be configured to execute instructions that are part of one or more applications, services, or other logical constructs. The logic subsystem may include one or more hardware processors configured to execute software instructions. Additionally, or alternatively, the logic subsystem may include one or more hardware or firmware devices configured to execute hardware or firmware instructions. Processors of the logic subsystem may be single-core or multi-core, and the instructions executed thereon may be configured for sequential, parallel, and/or distributed processing. Individual components of the logic subsystem optionally may be distributed among two or more separate devices, which may be remotely located and/or configured for coordinated processing. Aspects of the logic subsystem may be virtualized and executed by remotely-accessible, networked computing devices configured in a cloud-computing configuration.

Storage subsystem 804 includes one or more physical devices configured to temporarily and/or permanently hold computer information, such as data and instructions executable by the logic subsystem. When the storage subsystem includes two or more devices, the devices may be collocated and/or remotely located. Storage subsystem 804 may include volatile, nonvolatile, dynamic, static, read/write, read-only, random-access, sequential-access, location-addressable, file-addressable, and/or content-addressable devices. Storage subsystem 804 may include removable and/or built-in devices. When the logic subsystem executes instructions, the state of storage subsystem 804 may be transformed—e.g., to hold different data.

Aspects of logic subsystem 802 and storage subsystem 804 may be integrated together into one or more hardware-logic components. Such hardware-logic components may include program- and application-specific integrated circuits (PASIC/ASICs), program- and application-specific standard products (PSSP/ASSPs), system-on-a-chip (SOC), and complex programmable logic devices (CPLDs), for example.

The logic subsystem and the storage subsystem may cooperate to instantiate one or more logic machines. As used herein, the term “machine” is used to collectively refer to the combination of hardware, firmware, software, instructions, and/or any other components cooperating to provide computer functionality. In other words, “machines” are never abstract ideas and always have a tangible form. A machine may be instantiated by a single computing device, or a machine may include two or more sub-components instantiated by two or more different computing devices. In some implementations a machine includes a local component (e.g., software application executed by a computer processor) cooperating with a remote component (e.g., cloud computing service provided by a network of server computers). The software and/or other instructions that give a particular machine its functionality may optionally be saved as one or more unexecuted modules on one or more suitable storage devices.

When included, display subsystem 806 may be used to present a visual representation of data held by storage subsystem 804. This visual representation may take the form of a graphical user interface (GUI). Display subsystem 806 may include one or more display devices utilizing virtually any type of technology. In some implementations, display subsystem 806 may include one or more virtual-, augmented-, or mixed reality displays.

When included, input subsystem 808 may comprise or interface with one or more input devices. An input device may include a sensor device or a user input device. Examples of user input devices include a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition.

When included, communication subsystem 810 may be configured to communicatively couple computing system 800 with one or more other computing devices. Communication subsystem 810 may include wired and/or wireless communication devices compatible with one or more different communication protocols. The communication subsystem may be configured for communication via personal-, local- and/or wide-area networks.

This disclosure is presented by way of example and with reference to the associated drawing figures. Components, process steps, and other elements that may be substantially the same in one or more of the figures are identified coordinately and are described with minimal repetition. It will be noted, however, that elements identified coordinately may also differ to some degree. It will be further noted that some figures may be schematic and not drawn to scale. The various drawing scales, aspect ratios, and numbers of components shown in the figures may be purposely distorted to make certain features or relationships easier to see.

In an example, a method for automatic product authenticity verification includes: at an authentication computing system, computer-recognizing one or more observed identifying parameters of a candidate physical product, the candidate physical product associated with a product identifier; computer-identifying a block of a digital blockchain referencing the product identifier, the block including one or more recorded identifying parameters for a genuine physical product, wherein the one or more recorded identifying parameters are previously provided by a source party that produced the genuine physical product; and computer-evaluating an authenticity of the candidate physical product by automatically comparing the one or more observed identifying parameters of the candidate physical product to the one or more recorded identifying parameters for the genuine physical product. In this example or any other example, computer-evaluating the authenticity of the candidate physical product includes, based on determining that the one or more observed identifying parameters match the one or more recorded identifying parameters to within a similarity threshold, validating the candidate physical product as the genuine physical product. In this example or any other example, computer-evaluating the authenticity of the candidate physical product includes, based on determining that the one or more observed identifying parameters do not match the one or more recorded identifying parameters to within a similarity threshold, rejecting the candidate physical product as an inauthentic counterfeit of the genuine physical product. In this example or any other example, computer-evaluating the authenticity of the candidate physical product includes creating a record in the digital blockchain specifying an evaluated authenticity result for the candidate physical product. In this example or any other example, the record in the digital blockchain is created via execution of a smart contract of the digital blockchain. In this example or any other example, the digital blockchain includes a transportation record specifying the product identifier, the transportation record provided by a supplier that transported the candidate physical product. In this example or any other example, the block further includes one or more product identifiers and sets of recorded identifying parameters corresponding to one or more other genuine physical products produced by the source party. In this example or any other example, one or both of the product identifier and a blockchain address of the block are specified by a physical tag attached to the candidate physical product. In this example or any other example, the one or more recorded identifying parameters of the genuine physical product are encrypted in the block of the digital blockchain. In this example or any other example, the one or more observed identifying parameters of the candidate physical product include one or more of a weight of the candidate physical product, measured dimensions of the candidate physical product, a color of the candidate physical product, a material composition of the candidate physical product, a paint composition of the candidate physical product, and a placement of one or more identifying marks on the candidate physical product. In this example or any other example, computer-recognizing the one or more observed identifying parameters includes defining a virtual grid relative to a predefined reference point on the candidate physical product, and recognizing grid coordinates of the virtual grid occupied by the one or more identifying marks. In this example or any other example, the digital blockchain is cooperatively maintained by two or more computing devices, including at least the authentication computing system and a blockchain computing system associated with the source party. In this example or any other example, computer-recognizing the one or more observed identifying parameters includes quantifying the one or more observed identifying parameters based on sensor data output by one or more sensors of the authentication computing system.

In an example, an authentication computing system comprises: a logic subsystem; and a storage subsystem holding instructions executable by the logic subsystem to: computer-recognize one or more observed identifying parameters of a candidate physical product, the candidate physical product associated with a product identifier; computer-identify a block of a digital blockchain referencing the product identifier, the block including one or more recorded identifying parameters for a genuine physical product, wherein the one or more recorded identifying parameters are previously provided by a source party that produced the genuine physical product; and computer-evaluate an authenticity of the candidate physical product by automatically comparing the one or more observed identifying parameters of the candidate physical product to the one or more recorded identifying parameters for the genuine physical product. In this example or any other example, computer-evaluating the authenticity of the candidate physical product includes, based on determining that the observed identifying parameters match the recorded identifying parameters to within a similarity threshold, validating the candidate physical product as the genuine physical product. In this example or any other example, computer-evaluating the authenticity of the candidate physical product includes, based on determining that the observed identifying parameters do not match the recorded identifying parameters to within a similarity threshold, rejecting the candidate physical product as an inauthentic counterfeit of the genuine physical product. In this example or any other example, computer-evaluating the authenticity of the candidate physical product includes creating a record in the digital blockchain specifying an evaluated authenticity result for the candidate physical product. In this example or any other example, one or both of the unique product identifier and a blockchain address of the block are specified by a physical tag attached to the candidate physical product. In this example or any other example, the one or more observed identifying parameters of the candidate physical product include one or more of a weight of the candidate physical product, measured dimensions of the candidate physical product, a color of the candidate physical product, a material composition of the candidate physical product, a paint composition of the candidate physical product, and a placement of one or more identifying marks on the candidate physical product.

In an example, a method for automatic product authenticity verification comprises: at an authentication computing system, receiving sensor data output by one or more sensors, the sensor data quantifying one or more observed identifying parameters of a candidate physical product, and the candidate physical product associated with a product identifier; computer-identifying a block of a digital blockchain referencing the unique product identifier, the block including a set of recorded identifying parameters for a genuine physical product, wherein the one or more recorded identifying parameters are previously provided by an original equipment manufacturer (OEM) that manufactured the genuine physical product; computer-evaluating an authenticity of the candidate physical product by automatically comparing the one or more observed identifying parameters of the candidate physical product to the one or more recorded identifying parameters for the genuine physical product; based on determining that the one or more observed identifying parameters do not match the one or more recorded identifying parameters to within a similarity threshold, rejecting the candidate physical product as an inauthentic counterfeit of the genuine physical product; and creating a record in the digital blockchain specifying an evaluated authenticity result for the candidate physical product.

1. A method for automatic product authenticity verification, the method comprising:
at an authentication computing system, computer-recognizing one or more observed identifying parameters of a candidate physical product, the candidate physical product associated with a product identifier;
computer-identifying a block of a digital blockchain referencing the product identifier, the block including one or more recorded identifying parameters for a genuine physical product, wherein the one or more recorded identifying parameters are previously provided by a source party that produced the genuine physical product; and
computer-evaluating an authenticity of the candidate physical product by automatically comparing the one or more observed identifying parameters of the candidate physical product to the one or more recorded identifying parameters for the genuine physical product.

2. The method of claim 1, wherein computer-evaluating the authenticity of the candidate physical product includes, based on determining that the one or more observed identifying parameters match the one or more recorded identifying parameters to within a similarity threshold, validating the candidate physical product as the genuine physical product.

3. The method of claim 1, wherein computer-evaluating the authenticity of the candidate physical product includes, based on determining that the one or more observed identifying parameters do not match the one or more recorded identifying parameters to within a similarity threshold, rejecting the candidate physical product as an inauthentic counterfeit of the genuine physical product.

4. The method of claim 1, wherein computer-evaluating the authenticity of the candidate physical product includes creating a record in the digital blockchain specifying an evaluated authenticity result for the candidate physical product.

5. The method of claim 4, wherein the record in the digital blockchain is created via execution of a smart contract of the digital blockchain.

6. The method of claim 1, wherein the digital blockchain includes a transportation record specifying the product identifier, the transportation record provided by a supplier that transported the candidate physical product.

7. The method of claim 1, wherein the block further includes one or more product identifiers and sets of recorded identifying parameters corresponding to one or more other genuine physical products produced by the source party.

8. The method of claim 1, wherein one or both of the product identifier and a blockchain address of the block are specified by a physical tag attached to the candidate physical product.

9. The method of claim 1, wherein the one or more recorded identifying parameters of the genuine physical product are encrypted in the block of the digital blockchain.

10. The method of claim 1, wherein the one or more observed identifying parameters of the candidate physical product include one or more of a weight of the candidate physical product, measured dimensions of the candidate physical product, a color of the candidate physical product, a material composition of the candidate physical product, a paint composition of the candidate physical product, and a placement of one or more identifying marks on the candidate physical product.

11. The method of claim 10, wherein computer-recognizing the one or more observed identifying parameters includes defining a virtual grid relative to a predefined reference point on the candidate physical product, and recognizing grid coordinates of the virtual grid occupied by the one or more identifying marks.

12. The method of claim 1, wherein the digital blockchain is cooperatively maintained by two or more computing devices, including at least the authentication computing system and a blockchain computing system associated with the source party.

13. The method of claim 1, wherein computer-recognizing the one or more observed identifying parameters includes quantifying the one or more observed identifying parameters based on sensor data output by one or more sensors of the authentication computing system.

14. An authentication computing system, comprising:
a logic subsystem; and
a storage subsystem holding instructions executable by the logic subsystem to:
computer-recognize one or more observed identifying parameters of a candidate physical product, the candidate physical product associated with a product identifier;
computer-identify a block of a digital blockchain referencing the product identifier, the block including one or more recorded identifying parameters for a genuine physical product, wherein the one or more recorded identifying parameters are previously provided by a source party that produced the genuine physical product; and
computer-evaluate an authenticity of the candidate physical product by automatically comparing the one or more observed identifying parameters of the candidate physical product to the one or more recorded identifying parameters for the genuine physical product.

15. The authentication computing system of claim 14, wherein computer-evaluating the authenticity of the candidate physical product includes, based on determining that the observed identifying parameters match the recorded identifying parameters to within a similarity threshold, validating the candidate physical product as the genuine physical product.

16. The authentication computing system of claim 14, wherein computer-evaluating the authenticity of the candidate physical product includes, based on determining that the observed identifying parameters do not match the recorded identifying parameters to within a similarity threshold, rejecting the candidate physical product as an inauthentic counterfeit of the genuine physical product.

17. The authentication computing system of claim 14, wherein computer-evaluating the authenticity of the candidate physical product includes creating a record in the digital blockchain specifying an evaluated authenticity result for the candidate physical product.

18. The authentication computing system of claim 14, wherein one or both of the unique product identifier and a blockchain address of the block are specified by a physical tag attached to the candidate physical product.

19. The authentication computing system of claim 14, wherein the one or more observed identifying parameters of the candidate physical product include one or more of a weight of the candidate physical product, measured dimensions of the candidate physical product, a color of the candidate physical product, a material composition of the candidate physical product, a paint composition of the candidate physical product, and a placement of one or more identifying marks on the candidate physical product.

20. A method for automatic product authenticity verification, the method comprising:
at an authentication computing system, receiving sensor data output by one or more sensors, the sensor data quantifying one or more observed identifying parameters of a candidate physical product, and the candidate physical product associated with a product identifier;
computer-identifying a block of a digital blockchain referencing the unique product identifier, the block including a set of recorded identifying parameters for a genuine physical product, wherein the one or more recorded identifying parameters are previously provided by an original equipment manufacturer (OEM) that manufactured the genuine physical product;
computer-evaluating an authenticity of the candidate physical product by automatically comparing the one or more observed identifying parameters of the candidate physical product to the one or more recorded identifying parameters for the genuine physical product;
based on determining that the one or more observed identifying parameters do not match the one or more recorded identifying parameters to within a similarity threshold, rejecting the candidate physical product as an inauthentic counterfeit of the genuine physical product; and
creating a record in the digital blockchain specifying an evaluated authenticity result for the candidate physical product.
